(19) United States
(12) Patent Application Publication
(10) Pub. No.: US 2026/0247067 A1
(43) Pub. Date: Aug. 20, 2026

(54) LOUDSPEAKER ARRANGEMENT FOR A VEHICLE

(71) Applicant: PSS BELGIUM NV, Dendermonde (BE)

(72) Inventor: Tom HAELVOET, Dendermonde (BE)

(21) Appl. No.: 19/121,256

(22) PCT Filed: Oct. 20, 2023
(86) PCT No.: PCT/EP2023/079254

§ 371 Date: Apr. 15, 2025

(30) Foreign Application Priority Data
Oct. 28, 2022 (GB) 2215989.1

(51) Int. Cl. H04R 1/34; B60R 11/00; B60R 11/02; H04R 1/02; H04R 7/12; H04R 7/14

(52) U.S. Cl. CPC H04R 1/345; B60R 11/0217; H04R 1/025; H04R 7/127; H04R 7/14; B60R 2011/0021; H04R 2499/13

(57) ABSTRACT

A loudspeaker for a vehicle comprising: a loudspeaker module, an interior panel, and a separation panel. The loudspeaker module includes a loudspeaker and a waveguide. The loudspeaker has a diaphragm having first and second radiating surfaces The radiating surfaces are on opposite faces of the diaphragm. The interior panel defines an opening between the interior panel and a floor of the vehicle. The separation panel acoustically separates a first zone from a second zone. The separation panel has an aperture, wherein the loudspeaker is mounted across the aperture such that sound radiated by the first radiating surface is directed into the first zone and sound radiated by the second radiating surface is directed into the second zone. The waveguide guides sound radiated from the first radiating surface of the diaphragm downward to the opening so that the sound can radiate through the opening into the interior of the vehicle.

This application claims priority to GB2215989.1 filed 28 Oct. 2022.

### FIELD OF THE INVENTION

The present invention relates to a loudspeaker arrangement for use in a vehicle.

### BACKGROUND

Traditional automotive sound systems for vehicles typically use woofers located in the vehicle doors for production of bass and mid-range frequency sound, typically up to 3 kHz. A vehicle door commonly has a wet zone at least partially exposed to the vehicle exterior and a dry zone which is isolated from the vehicle exterior. The acoustic volume of the wet zone is typically large and may be used as a loudspeaker back volume for a woofer located in a vehicle door. The remainder of the woofer is generally located in the dry zone and sound is radiated into the interior of the vehicle through a speaker grille provided in the door trim.

The present inventor has observed that it is desirable for a vehicle sound system to occupy as little space as possible so that the vehicle interior may have more space available for storage, freedom of movement for the user (more leg space for example) and a general sense of space.

Some known solutions to providing sound systems in vehicles which take up less space include the use of shallower speaker designs (for example a speaker with a folded membrane as discussed in WO2005/015950A1) or moving the loudspeakers to another location in the vehicle (for example a loudspeaker may be coupled with a chassis element below the floor of the vehicle). However, locations in a vehicle for loudspeakers are limited, particularly for woofers, because a sufficiently large back volume is required in order to produce high quality sound.

JPH11225388A describes methods of coupling a speaker with a waveguide to an opening in a car cabin. However, JPH11225388A also mentions that compact integration of the speaker can be a challenge and protection against the accumulation of dust and small particles must be provided, for example with a speaker grille which would be visible from the interior of the vehicle.

Accordingly, the present inventor has observed that there is a need for an improved compact loudspeaker arrangement for producing high quality bass sound in a vehicle.

U.S. Pat. No. 5,737,435 discloses a sound reproducing apparatus comprising an acoustic horn.

U.S. Pat. No. 10,882,461 discloses an acoustic conduit which provides a waveguide for coupling a loudspeaker inside a vehicle to a region outside the vehicle.

The present invention has been devised in light of the above considerations.

### SUMMARY OF THE INVENTION

A first aspect of the present invention may provide: A loudspeaker arrangement for use in a vehicle comprising:
a loudspeaker module including:
   a loudspeaker having: a diaphragm having a first radiating surface and a second radiating surface, wherein the first radiating surface and the second radiating surface are located on opposite faces of the diaphragm, and a drive unit configured to move the diaphragm based on an electrical signal;
   a waveguide configured to guide sound radiated from the first radiating surface of the diaphragm;
an interior panel configured to be positioned between the loudspeaker and an interior of a vehicle, wherein the interior panel is configured to define an opening between the interior panel and a floor of the vehicle;
a separation panel configured to acoustically separate a first zone from a second zone, wherein the separation panel has an aperture, wherein the loudspeaker is mounted across the aperture such that sound radiated by the first radiating surface is directed into the first zone and sound radiated by the second radiating surface is directed into the second zone;
wherein the waveguide is configured to guide sound radiated from the first radiating surface of the diaphragm in a downward direction to the opening so that the sound can radiate through the opening into the interior of the vehicle.

Herein, where a component is described as being “configured to” have some function in relation to some element of a vehicle, this may be taken to be configured to have this function when the loudspeaker arrangement is used (e.g. installed) in the vehicle.

Advantageously, the interior panel being positioned between the loudspeaker and an interior of the vehicle hides the loudspeaker from the view of occupants in the vehicle. This can protect the loudspeaker without the need for a grille. This can also provide an interior designer more freedom in designing the interior of the vehicle around the loudspeaker since they do not need to incorporate speaker grills in the interior panel. This may also improve the aesthetics of the vehicle interior.

In addition, the present inventors have observed that coupling the waveguide to the interior of the car via the opening between the interior panel and a floor of the vehicle can improve the performance of the speaker arrangement when producing bass frequencies. Without wishing to be bound by theory, it is thought that this is because positioning the opening near the floor of the vehicle results in the floor acting as a surface which reflects bass frequencies towards the interior of the vehicle.

In some examples, the opening may be formed between a bottom end of the interior panel and a floor of the vehicle.

The present inventors have observed that a loudspeaker arrangement according to the first aspect of the invention does not project higher frequencies very well (typically above 1 kHz), when used in a vehicle. Without wishing to be bound by theory, it is believed this can be attributed to:
The lower position and downward orientation of the waveguide away from the listener, which can hamper the propagation of higher frequencies while the propagation of lower frequencies can remain substantially unaffected.
Absorbing materials, when present close to the opening (e.g. a carpet on the floor of the vehicle), and other obstructions which may be present in the vehicle (e.g. seats, passengers, luggage . . . ) , can lead to further damping of higher frequencies while the propagation of lower frequencies can again remain substantially unaffected.

Some additional acoustic considerations associated with a waveguide configured to guide sound to an opening are discussed, for example, in JPH11225388A.

The drive unit may be an electromagnetic drive unit that includes a magnet unit configured to produce a magnetic field in an air gap, and a voice coil attached to the diaphragm, wherein the voice coil is configured to sit in the air gap when the diaphragm is at rest. When the loudspeaker is in use, the voice coil may be energized (e.g. by having the electrical signal pass through it) to produce a magnetic field which interacts with the magnetic field produced by the magnet unit and which causes the voice coil (and therefore the diaphragm) to move along a movement axis relative to the magnet unit. Such drive units are well known.

The waveguide may be configured to direct sound from the first radiating surface towards a mouth of the waveguide.

In some examples where the waveguide has a mouth, the mouth of the waveguide may be located before the opening defined between the interior panel and the floor of the vehicle, with the mouth of the waveguide being configured to direct sound towards the opening between the interior panel and the floor of the vehicle (where it can propagate out into the interior of the vehicle). In some other examples where the waveguide has a mouth, the mouth of the waveguide may be formed at the opening defined between the interior panel and the floor of the vehicle. In some yet further examples where the waveguide has a mouth, the mouth of the waveguide may be located beyond the opening defined between the interior panel and the floor of the vehicle, with the waveguide guiding sound through the opening between the interior panel and the floor of the vehicle prior to that sound reaching the mouth of the waveguide (and out into the interior of the vehicle).

For avoidance of any doubt, the waveguide can be considered to guide sound in a downward direction if the waveguide guides sound from the first radiating surface to the mouth of the waveguide, wherein the mouth of the waveguide is at least partly lower (in some cases the mouth of the waveguide may be entirely lower) than the first radiating surface when the loudspeaker arrangement is in normal use (e.g. when the loudspeaker arrangement is installed in a vehicle, and the vehicle is upright). In this context, sound may be directed vertically downwards, downwards at an angle to vertical, or along a tortuous (not straight line) path. The mouth of the waveguide may be directly below or laterally displaced from the first radiating surface in a horizontal direction.

In some examples, the term “in a downwards direction to the opening” may be replaced with “in a direction towards the floor of the vehicle and to the opening”.

In some examples, the floor of the vehicle may not be flat. For example, the floor of the vehicle may follow the shape of a wheel arch of the vehicle. In these examples, the waveguide may, for example, be configured to guide sound radiated from the first radiating surface of the diaphragm in a downward direction which is at an angle (e.g. an acute angle) from vertical, or along a non-straight line path. Therefore, sound may be directed around the wheel arch (or other obstructions) hence improving the perceived performance of the loudspeaker arrangement.

The loudspeaker arrangement may be comprised by a door of the vehicle. In this example, the interior panel may be the interior panel of the door. The interior panel may also be referred to as a door trim.

Because the loudspeaker is mounted across the aperture in the separation panel such that sound radiated by the first radiating surface is directed into the first zone and sound radiated by the second radiating surface is directed into the second zone, the diaphragm may be considered to also serve to acoustically separate the first zone from the second zone.

When the loudspeaker arrangement is comprised by a door of the vehicle the first zone may be a dry zone of the vehicle door. In this case, the second zone of the loudspeaker may be a wet zone of the vehicle door. The wet zone may comprise a chamber for receiving a vehicle window when the window is retracted.

The diaphragm may be waterproof to inhibit water ingress from the second zone to the first zone. This may be useful if the second zone is a wet zone of a door of a vehicle or if the second zone is an exterior of a vehicle.

When the loudspeaker arrangement is comprised by a door of the vehicle, the opening between the interior panel and a floor of the vehicle may be formed between the interior panel and a doorstep which forms part of the floor of the vehicle.

In some examples, the loudspeaker arrangement may be a door of a vehicle.

The opening between the interior panel and a floor of the vehicle, when the loudspeaker arrangement is used in a vehicle, may comprise a clearance between the floor and the interior panel of 5 mm-80 mm in a vertical direction. More preferably, there may be a clearance of 5 mm-50 mm in the vertical direction. Advantageously, this clearance can help to ensure that an adequate airflow is possible from the waveguide to the interior of the vehicle through the opening so that sound may radiate from the loudspeaker into the interior of the vehicle at a desired volume and quality.

The opening between the interior panel and a floor of the vehicle, when the loudspeaker arrangement is used in a vehicle, may have a horizontal length that is larger than a maximal width of the loudspeaker. In other examples, the horizontal length may be shorter than the maximal width of the loudspeaker. The horizontal length of the opening may be between 50% and 200% of the maximal width of the diaphragm. An opening in this range may help to allow an adequate amount of sound from the loudspeaker enter the vehicle.

Here the “maximal width” of the loudspeaker refers to the largest extent of the diaphragm module in a width direction. If the diaphragm is circular, the maximal width may correspond to the diameter of the loudspeaker.

The horizonal length may be as measured when the loudspeaker arrangement is in normal use (e.g. when the loudspeaker arrangement is installed in a vehicle, and the vehicle is upright).

The drive unit may be mounted directly to the waveguide. In this way, the waveguide may act a speaker basket or chassis of the loudspeaker (in addition to acting as the waveguide). By mounting the drive unit directly to the waveguide, the overall thickness of the loudspeaker module may be reduced. Reducing the overall thickness of the loudspeaker module enables more space for other functions such as storage or legroom to be accommodated in the vehicle.

In other examples, the drive unit may be mounted to a loudspeaker chassis (separate from the waveguide) which is configured to let sound radiated by the first radiating surface to pass out of the loudspeaker chassis. In such examples, the waveguide may be formed by the interior panel itself.

The loudspeaker may be mounted in an inverted arrangement wherein the drive unit is positioned in the first zone, rather than in the second zone. In this example, sound radiated by the first radiating surface of the diaphragm may be radiated towards the drive unit, and sound radiated by the second radiating surface of the diaphragm may be radiated away from the drive unit. This loudspeaker arrangement may be considered to be an inverted orientation because the first radiating surface of the diaphragm (used to produce sound that is listened to) radiates sound towards, rather than away from, the drive unit.

An advantage of using an inverted loudspeaker arrangement is that the drive unit can be mounted directly to the waveguide, e.g. mounted to a surface on the interior of the waveguide which faces towards the diaphragm, which can facilitate the implementation of a thinner loudspeaker module enabling more room for storage or other uses to be made available, and can also reduce the amount by which the loudspeaker projects into the second zone.

Here we note that when the loudspeaker arrangement is located in a door of the vehicle it may be necessary for a window of the door to be stored in the second zone (e.g. wet zone) of the vehicle door. In this case, reducing the amount by which the loudspeaker projects into the second zone is particularly helpful to facilitate storage of the window when it is retracted into the door.

The maximal depth of the loudspeaker module, when the drive unit is at rest, may be 80 mm or less, more preferably less than 60 mm, more preferably less than 50 mm or less. Here, the “maximal depth” refers to the largest extent of the loudspeaker module in a depth direction. The depth direction may be parallel to a movement axis of the drive unit. The depth direction may be horizontal. By including a loudspeaker module with such a depth, more room for storage or other uses may be made available. This can also reduce the amount by which the loudspeaker projects into the second zone.

The diaphragm may comprise a one or more (e.g. a pattern of) folds (most appropriate if the diaphragm is of a sheet material, such as paper). This may help to reduce the height of the loudspeaker (e.g. in a direction parallel to a movement axis of the drive unit), whilst still maintaining a stable loudspeaker. The/each fold may, when viewed in a circumferential direction, radially extend between an inner circumferential edge and an outer circumferential edge of the diaphragm. The/each fold may have a depth which increases from the outer circumferential edge, and the inner circumferential edge, of the diaphragm towards a base region positioned between (e.g. approximately mid-way between) the outer circumferential edge and the inner circumferential edge of the diaphragm. Accordingly, a maximum depth of the/each fold may be located at the base region. The/each fold may be provided with a respective face in the base region. Examples of possible patterns of folds are described in WO2005/015950A1.

Advantageously, by including a diaphragm with one or more folds may reduce the total thickness of the loudspeaker module enabling more room for storage or other uses to be made available. This can also reduce the amount by which the loudspeaker projects into the second zone.

The second zone may be a back volume or chamber for receiving sound radiated from the second radiating surface of the diaphragm. The back volume may be a wet zone of a vehicle door which may be exposed to the exterior of the vehicle to some degree. The wet zone may be configured to receive a vehicle window if the loudspeaker arrangement is located in a door of the vehicle.

In other examples, the second zone may be an exterior of the vehicle. In this example, the sound from the second radiating surface of the diaphragm may be radiated directly into the environment surrounding the vehicle through the aperture in the separating panel. In some examples, a second waveguide may be provided to direct sound radiating from the second radiating surface of the diaphragm from the aperture in the radiating surface to the exterior of the vehicle.

The loudspeaker arrangement may include one or more acoustic seals for facilitating acoustic isolation of the first zone from the second zone. For example, an acoustic seal may be provided around the aperture in the separation panel between the loudspeaker module and the separation panel. An acoustic seal may also be provided between the waveguide and the interior panel. The acoustic seals may be made of rubber. For example, EPDM, PUR, or PE.

The loudspeaker may be a woofer configured to produce sound at frequencies which do not exceed 3 kHz. In some examples, the loudspeaker may be configured to produce sound at frequencies which do not exceed 1 kHz, and which in some examples do not exceed 500 Hz or 200 Hz (noting that in some applications, e.g. in car doors, woofers may be crossed to midranges at around 200 Hz). By providing sound at frequencies which do not exceed such example values, the loudspeaker arrangement may avoid/reduce the problems associated with poor projection of higher frequencies (typically above 1 kHz) as discussed above. Accordingly, the overall performance of the loudspeaker arrangement may be improved at low frequencies compared to conventional loudspeaker arrangements for use in vehicles.

Frequencies above those produced by the woofer (e.g. 3 kHz, 1 kHz, 500 Hz, or 200 Hz) may be provided by one or more additional loudspeakers, e.g. one full range speaker, or one mid-range speaker and one tweeter. The additional loudspeaker(s) may be mounted on the interior panel (e.g. entirely within a dry zone of a vehicle door).

A second aspect of the present invention may provide a vehicle comprising the loudspeaker arrangement according to the first aspect of the invention.

Accordingly, the second aspect of the invention may provide a vehicle comprising:
a loudspeaker module including:
   a loudspeaker having: a diaphragm having a first radiating surface and a second radiating surface, wherein the first radiating surface and the second radiating surface are located on opposite faces of the diaphragm, and a drive unit configured to move the diaphragm based on an electrical signal;
   a waveguide configured to guide sound radiated from the first radiating surface of the diaphragm;
an interior panel positioned between the loudspeaker and an interior of the vehicle, wherein the interior panel defines an opening between the interior panel and a floor of the vehicle;
a separation panel which acoustically separates a first zone acoustically connected to an interior of the vehicle from a second zone, wherein the separation panel has an aperture, wherein the loudspeaker is mounted across the aperture such that sound radiated by the first radiating surface is directed into the first zone and sound radiated by the second radiating surface is directed into the second zone;
wherein the waveguide is configured to guide sound radiated from the first radiating surface of the diaphragm in a downward direction to the opening so that the sound can radiate into the interior of the vehicle.

A third aspect of the present invention may provide a loudspeaker module configured for use in a loudspeaker arrangement according to the first aspect of the invention or a vehicle according to the second aspect of the invention.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a loudspeaker arrangement according to the present disclosure;

FIGS. 2a and 2b show front and rear perspective views of the loudspeaker module of FIG. 1; and

FIG. 3 shows a second loudspeaker arrangement according to the present disclosure.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

In the examples that follow, alike features have been given corresponding reference numerals, and corresponding descriptions may apply except where such a description is clearly impermissible or expressly avoided.

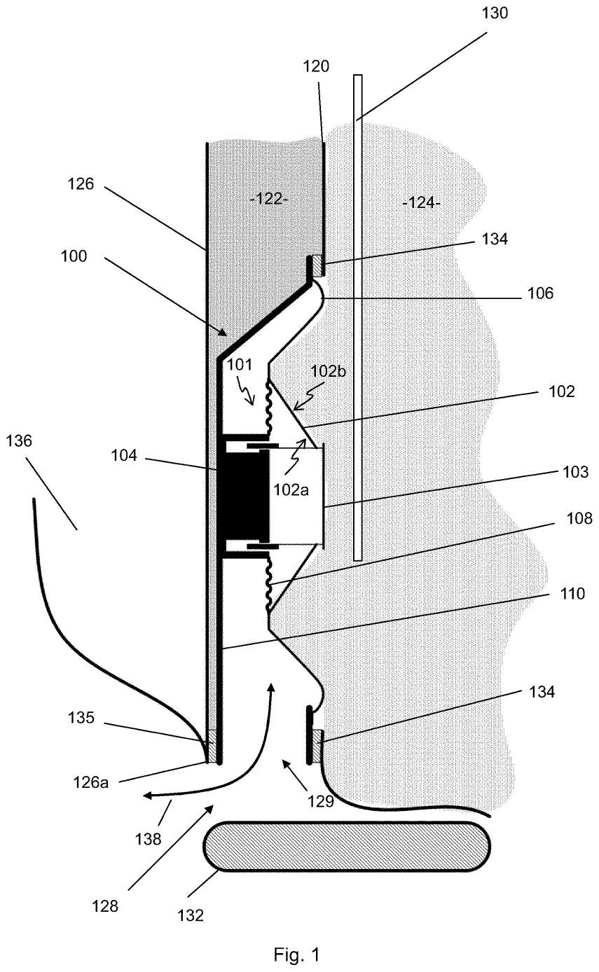

FIG. 1 shows a loudspeaker arrangement according to the present invention comprising a loudspeaker module 100, an interior panel 126 and a separation panel 120. In this example, the loudspeaker arrangement is comprised by a door of a vehicle.

The loudspeaker module 100 includes a loudspeaker 101 and a waveguide 110. The loudspeaker 101 includes a diaphragm 102 and a drive unit 104. The diaphragm 102 has a first radiating surface 102a and a second radiating surface 102b, located on opposite faces of the diaphragm 102. The drive unit 104 is configured to move the diaphragm 102 based on an electrical signal such that the first and second radiating surfaces radiate sound. The waveguide 110 is configured to guide sound radiated from the first radiating surface 102a of the diaphragm 102

In this example, the diaphragm 102 is suspended from the waveguide 110 by suspension elements in the form of a damper 108 (which may also be referred to as a “spider”) and a surround 106 (which may also be referred to as a “roll suspension” or “roll edge”). In this example, the diaphragm 102 is a cone and a dust cap 103.

In this example, the drive unit 104 is an electromagnetic drive unit 104 that includes a magnet unit configured to produce a magnetic field in an air gap, and a voice coil attached to the diaphragm 102. The voice coil is configured to sit in the air gap when the diaphragm 102 is at rest. When the loudspeaker 101 is in use, the voice coil may be energized (e.g. by having the electrical signal pass through it) to produce a magnetic field which interacts with the magnetic field produced by the magnet unit and which causes the voice coil (and therefore the diaphragm 102) to move along a movement axis relative to the magnet unit. Such drive units are well known.

The interior panel 126 (which may be referred to as a “door trim”) is positioned between the loudspeaker 101 and an interior of the vehicle. An opening 128 is defined by the interior panel 126 between the interior panel 126 and a floor 132 of the vehicle. In particular, the opening is formed between a bottom end 126a of the interior panel 126, and the floor 132 of the vehicle. In this example, the floor 132 of the vehicle comprises a doorstep which is positioned below the vehicle door when the door is closed. In this example, storage 136 is provided on the interior panel 126.

The separation panel 120 is configured to acoustically separate a first zone 122 from a second zone 124. In this example, the first zone 122 is a dry zone 122 of the vehicle door which is sealed from the exterior of the vehicle by the separation panel 120. The second zone 124 is a wet zone of the vehicle door which may be exposed to the exterior of the vehicle to some degree. Thus, the first (“dry”) zone is on an interior side of the separation panel 120, and the second (“wet”) zone is on an exterior side of the separation panel 120. In this example, the wet zone is configured to receive a vehicle window of the door and serves as a back volume for the loudspeaker 101.

In this example, the diaphragm 102 of the loudspeaker 101 is waterproof and thus prevents water ingress from the second (“wet”) zone into the first (“dry”) zone. For avoidance of any doubt, in the example shown in FIG. 1 the interior volume enclosed by the waveguide is considered to form part of the first (“dry”) zone.

In this example, the diaphragm 102 is circular, though other shapes are possible.

The separation panel 120 has an aperture and the loudspeaker 101 is mounted across the aperture such that sound radiated by the first radiating surface 102a is directed into the first zone 122 and sound radiated by the second radiating surface 102b is directed into the second zone 124.

The waveguide 110 is configured to guide sound radiated from the first radiating surface 102a of the diaphragm 102 in a downward direction to the opening 128 so that the sound can radiate through the opening (between the bottom end 126a of the interior panel 126 and the floor 132 of the vehicle) into the interior of the vehicle.

The loudspeaker arrangement includes an acoustic seal 134 for facilitating acoustic isolation of the first zone 122 from the second zone 124. An additional acoustic seal 135 is also provided between the waveguide 110 and the interior panel 126.

In this example the drive unit 104 is mounted directly to the waveguide 110, by mounting a magnet unit of the drive unit 104 directly to the waveguide 110. In particular, the magnet unit of the drive unit 104 is mounted to a surface on the interior of the waveguide 110 which faces towards the diaphragm 102, i.e. such that the waveguide 110 also acts as a chassis of the loudspeaker 101 (in addition to acting at the waveguide 110). In this example, the loudspeaker 101 is mounted to the waveguide 110 in an inverted arrangement wherein the drive unit 104 is positioned in the first zone 122, rather than in the second zone 124. In use, sound radiated by the first radiating surface 102a of the diaphragm 102 is radiated towards the drive unit 104, and sound radiated by the second radiating surface 102b of the diaphragm 102 is radiated away from the drive unit 104. The damper 108 may be configured to be acoustically transparent, e.g. by making this from a coarse fibre material, to facilitate the propagation of sound produced by the first radiating surface 102a into the waveguide 110.

The loudspeaker 101 is a loudspeaker with a narrow profile owing in part to the inverted arrangement and the waveguide 110 configuration. In this example, the maximal depth of the loudspeaker module 100 in a direction parallel to a movement axis of the drive unit 104 may be 50 mm or less.

In this example, the loudspeaker is a woofer configured to produce sound at frequencies which do not exceed 1 kHz.

The opening 128 between the interior panel 126 and the doorstep has a clearance between the doorstep and the interior panel 126 of 5 mm-50 mm in a vertical direction so that an adequate airflow 138 is possible from the waveguide 110 to the interior of the vehicle through the opening 128. The opening 128 between the interior panel 126 and the doorstep has a width in a horizontal direction of 50% to 200% of the diameter of the diaphragm 102 so that an adequate airflow 138 is possible from the waveguide 110 to the interior of the vehicle.

The interior panel 126 being positioned between the loudspeaker 101 and an interior of the vehicle hides the loudspeaker 101 from the view of occupants in the vehicle providing protection to the loudspeaker 101 and greater freedom in designing the interior of the vehicle. In addition, the present inventors have observed that the loudspeaker arrangement of FIG. 1 results in better overall performance of the loudspeaker arrangement at lower frequencies.

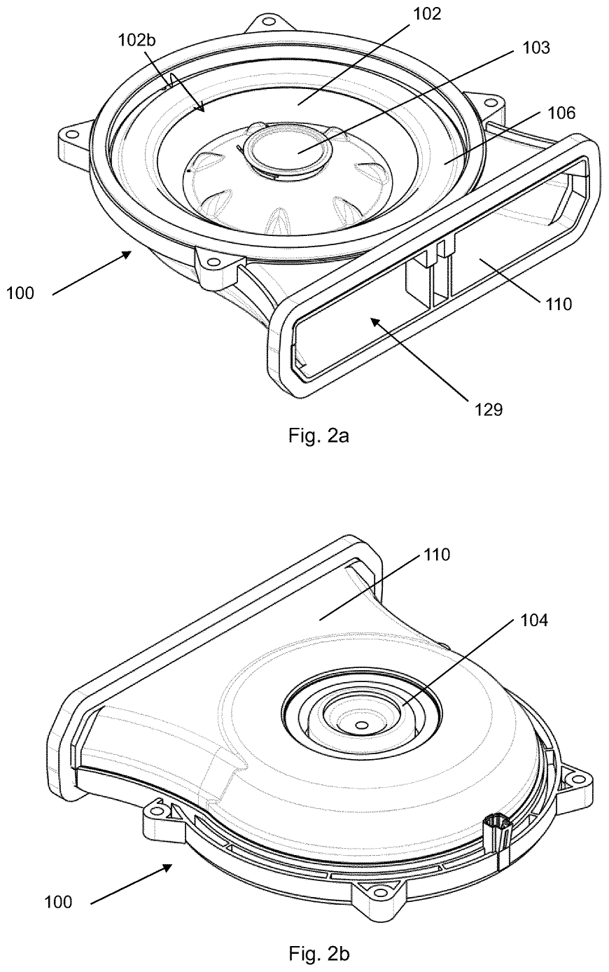

FIG. 2a shows a rear perspective view of the loudspeaker module 100 of FIG. 1. FIG. 2a shows a front perspective view of the loudspeaker module 100 of FIG. 2b.

In FIG. 2a the diaphragm 102, dust cap 103, and roll suspension 106 of the loudspeaker module 100 are mounted to the waveguide 110, which also serves as the loudspeaker chassis. The loudspeaker waveguide 110 is configured to guide sound radiated from the first radiating surface 102a of the diaphragm 102 towards a mouth 129 of the waveguide 110. The chassis is configured to fit over the aperture in the separation panel 120 such that sound radiated by the second radiating surface 102b of the diaphragm the diaphragm 102 is directed into the second zone 124.

We note that with the loudspeaker module 100 mounted as shown in FIG. 1, the mouth 129 of the waveguide 110 is located before the opening 128 defined between the interior panel 126 and the doorstep, i.e. with the mouth of the waveguide 129 being configured to direct sound towards the opening 128 (where it can propagate out into the interior of the vehicle).

In FIG. 2b, the waveguide 110 and rear of the drive unit 104 are visible. In the loudspeaker arrangement of FIG. 1 these features would be hidden from view behind the interior panel 126.

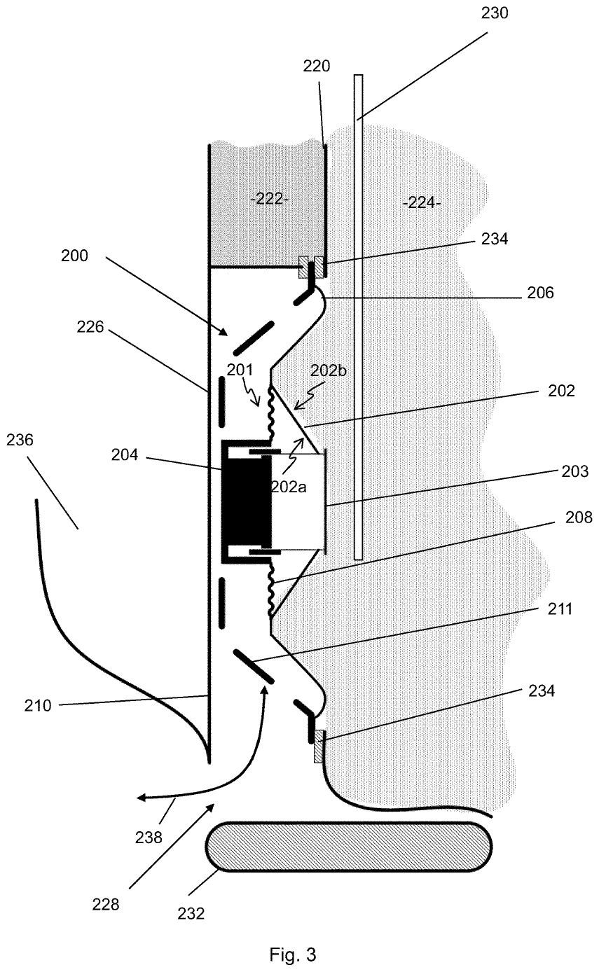

FIG. 3 shows a second loudspeaker arrangement according to the present invention wherein the loudspeaker 201 is mounted to a loudspeaker chassis 211. In this example, the loudspeaker chassis 211 is separate from the waveguide 210 and is configured to let sound radiated by the first radiating surface 202a of the diaphragm 202 to pass out of the loudspeaker chassis and into the waveguide 210. The waveguide 210 is formed by the interior panel 226 so that sound radiated by the first radiating surface 202a of the diaphragm 202 is guided in a downwards direction towards the opening 228 between the interior panel 226 and the floor of the vehicle 232.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For example, in relation to the example shown in FIG. 1, the second zone 124 may be an exterior of the vehicle, in which case sound from the second radiating surface 102b of the diaphragm may be radiated directly into the environment surrounding the vehicle

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.
WO2005/015950A1
JPH11225388A
U.S. Pat. No. 5,737,435
U.S. Pat. No. 10,882,461

1. A loudspeaker arrangement for use in a vehicle comprising:
a loudspeaker module including:
a loudspeaker having: a diaphragm having a first radiating surface and a second radiating surface, wherein the first radiating surface and the second radiating surface are located on opposite faces of the diaphragm, and a drive unit configured to move the diaphragm based on an electrical signal;
a waveguide configured to guide sound radiated from the first radiating surface of the diaphragm;
an interior panel configured to be positioned between the loudspeaker and an interior of a vehicle, wherein the interior panel is configured to define an opening between the interior panel and a floor of the vehicle;
a separation panel configured to acoustically separate a first zone from a second zone, wherein the separation panel has an aperture, wherein the loudspeaker is mounted across the aperture such that sound radiated by the first radiating surface is directed into the first zone and sound radiated by the second radiating surface is directed into the second zone;
wherein the waveguide is configured to guide sound radiated from the first radiating surface of the diaphragm in a downward direction to the opening so that the sound can radiate through the opening into the interior of the vehicle.

2. The loudspeaker arrangement of a claim 1 wherein the second zone is a chamber for receiving sound radiated from the second radiating surface of the diaphragm.

3. The loudspeaker arrangement of claim 1 wherein the second zone is an exterior of the vehicle.

4. The loudspeaker arrangement of claim 1 wherein the loudspeaker arrangement is included in a door of the vehicle, and the diaphragm is waterproof to inhibit water ingress from the second zone to the first zone.

5. The loudspeaker arrangement of claim 4 wherein the opening between the interior panel and the floor of the vehicle is formed between the interior panel and a doorstep of the vehicle.

6. The loudspeaker arrangement of claim 1 wherein the drive unit is mounted directly to the waveguide.

7. The loudspeaker arrangement of claim 1 wherein the drive unit is mounted to a loudspeaker chassis, wherein the loudspeaker chassis is configured to allow sound radiated by the first radiating surface to pass out of the loudspeaker chassis, and the waveguide is formed by the interior panel.

8. The loudspeaker arrangement of claim 1 wherein the loudspeaker is mounted in an inverted arrangement, wherein the drive unit is positioned in the first zone, and sound radiated by the first radiating surface of the diaphragm is radiated towards the drive unit, and sound radiated by the second radiating surface of the diaphragm is radiated away from the drive unit.

9. The loudspeaker arrangement of claim 1 wherein a height of the opening in a vertical direction between the interior panel and the floor of the vehicle is 5 mm-80 mm.

10. The loudspeaker arrangement of claim 1 wherein a horizontal length of the opening between the interior panel and the floor of the vehicle is 50% to 200% of a maximal width of the diaphragm.

11. The loudspeaker arrangement of claim 1 wherein the diaphragm comprises one or more folds.

12. The loudspeaker arrangement of claim 1 wherein the loudspeaker is a woofer configured to produce sound at frequencies which do not exceed 3 kHz.

13. A vehicle comprising a loudspeaker arrangement, the loudspeaker arrangement comprising:
a loudspeaker module including:
a loudspeaker having: a diaphragm having a first radiating surface and a second radiating surface, wherein the first radiating surface and the second radiating surface are located on opposite faces of the diaphragm, and a drive unit configured to move the diaphragm based on an electrical signal;
a waveguide configured to guide sound radiated from the first radiating surface of the diaphragm;
an interior panel configured to be positioned between the loudspeaker and an interior of a vehicle, wherein the interior panel is configured to define an opening between the interior panel and a floor of the vehicle;
a separation panel configured to acoustically separate a first zone from a second zone, wherein the separation panel has an aperture, wherein the loudspeaker is mounted across the aperture such that sound radiated by the first radiating surface is directed into the first zone and sound radiated by the second radiating surface is directed into the second zone;
wherein the waveguide is configured to guide sound radiated from the first radiating surface of the diaphragm in a downward direction to the opening so that the sound can radiate through the opening into the interior of the vehicle.

14. A loudspeaker module for use in a vehicle including:
a loudspeaker having: a diaphragm having a first radiating surface and a second radiating surface, wherein the first radiating surface and the second radiating surface are located on opposite faces of the diaphragm, and a drive unit configured to move the diaphragm based on an electrical signal;
a waveguide configured to guide sound radiated from the first radiating surface of the diaphragm;
wherein the waveguide is configured to, when installed in a vehicle, guide sound radiated from the first radiating surface of the diaphragm in a downward direction to an opening so that the sound can radiate through an opening between an interior panel and a floor of the vehicle into the interior of the vehicle.
